(19) United States
(12) Patent Application Publication
(10) Pub. No.: US 2009/0015686 A1
(43) Pub. Date: Jan. 15, 2009

(54) Hyperspectral Chemical and Property Imaging

(75) Inventor: Bjorn Alsberg, Trondheim (NO)

Correspondence Address: SUTHERLAND ASBILL & BRENNAN LLP, 999 PEACHTREE STREET, N.E., ATLANTA, GA, 30309, US

(73) Assignee: NTNU TECHNOLOGY TRANSFER AS, Trondheim (NO)

(21) Appl. No.: 12/162,486

(22) PCT Filed: Feb. 2, 2007
(86) PCT No.: PCT/GB07/00369

§ 371 Date: Jul. 29, 2008

(30) Foreign Application Priority Data
Feb. 2, 2006 (GB) 0602137.2

(51) Int. Cl. H04N 5/228; G06K 9/00; H04N 5/235

(52) U.S. Cl. 348/222.1; 382/100; 348/346; 348/E09.002; 348/E05.045; 348/E05.031

(57) ABSTRACT

An apparatus for displaying chemical projects a chemical image of an object back onto that object. At region (23) light travels from the object to the apparatus (20) and back from the apparatus as it projects onto the object. Light (24) from the object (22) (which is illuminated by natural light) passes through an objective lens (31) of the apparatus. In its path is rotating mirror (25) and when the mirror is parallel to the path of the rays of light (24), the light is allowed to pass on to hyperspectral camera (26) which is of the AOTF type. The output from the camera is transmitted to processor (27) where the chemical image is generated from the hyperspectral data. The camera generates a series of monochromatic images that are passed to the processor and the chemical image is built up as the camera scans through the appropriate wavelengths. The image data is then transmitted to a projector (28) whose output image is focussed by lens (30) towards the rotating mirror (25). When the mirror is in the position illustrated, the image is reflected off the mirror and back through lens (31) to the imaged object (22).

The present invention relates to apparatus and methods for producing chemical or property images more rapidly and with higher spectral resolution than was previously possible. In preferred forms, the invention enables real-time or quasi-real-time images to be produced using hyperspectral cameras. One aspect of the invention enables such images to be visualised more effectively.

A chemical (or property) image is an image where the concentration of given chemical(s) (or other property) is shown on a “map” of the sample that is being imaged. This is normally achieved by obtaining spectral information from a large number of spatial points in the sample.

A conventional digital camera produces a colour image by using a set of filters to separate the light into the red, green and blue bands. However, the data provided by the colours in such images is of very limited value for determining chemical properties of the sample. It is well known that if a spectrum is collected across a given wavelength range, e.g. the infra-red (IR) or near infra-red (NIR) regions, it can be used to reveal the chemical composition of the sample. In the case of IR and NIR, this is due to the absorption of particular frequencies by one or more chemical species within the sample. More generally, molecules absorb energy at different frequencies, which influence a range of properties such as vibration, rotation, transition between orbitals, nuclear resonance, etc. Thus, the absorption pattern at a certain set of frequencies can be used to identify different molecular species and physical properties.

Multispectral and hyperspectral cameras are now available that produce digital output in the form of spatially resolved spectral data. Where the output is less than ten different wavelengths then a multispectral image is produced, spatially resolved image data at a higher number of wavelengths is hyperspectral.

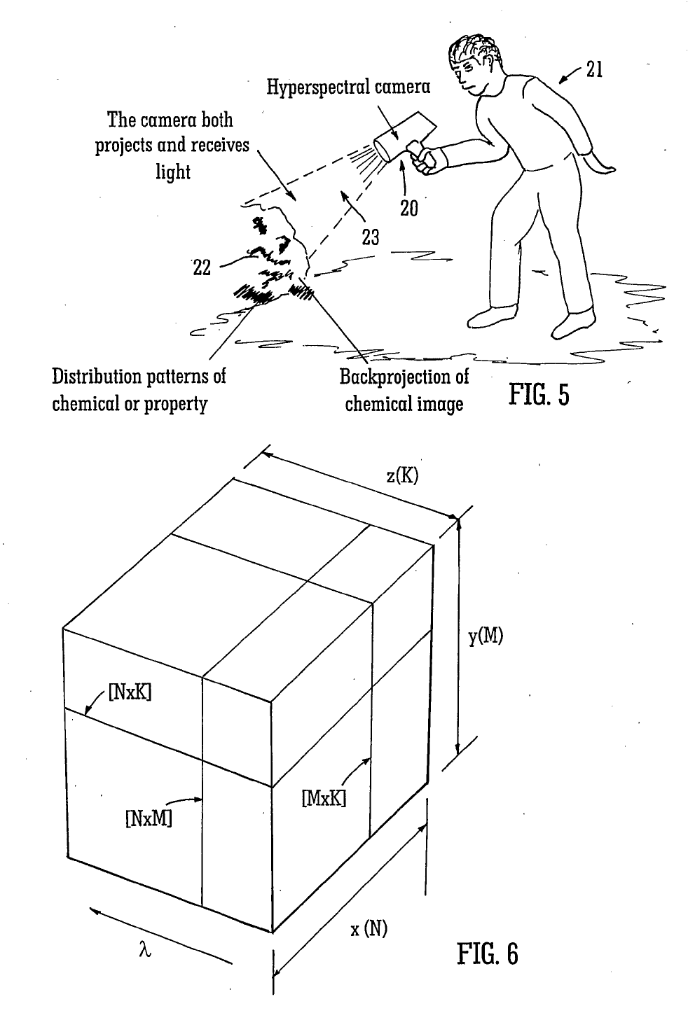

Thus, hyperspectral imaging is the acquisition of images across a large, usually contiguous, series of narrow spectral bands (i.e. at a series of different wavelengths) where the spectral data obtained is comparable to traditional (single-point) spectroscopic techniques. In this way, the complete spatial and spectroscopic information of the sample is integrated. Spectral images are visualized as a three-dimensional block of data spanning one wavelength and two spatial dimensions called a hyperspectral datacube or “hypercube”. For our discussion we will assume this cube has dimensions N×M×K, where N is the number of rows and M the number of columns of pixels and K is the number of wavelengths at which intensity values have been obtained. Thus for each pixel in the image there is a spectrum, i.e. a set of intensity/absorption values for each of a large number of discrete wavelengths. Such a hypercube is shown schematically in FIG. 6. By analysing each of the spectra, chemical composition data can be found for each pixel and this means that an image can be produced which shows the spatially resolved composition of the sample. This is known as a chemical image.

In a simple case, the spectra can be analysed to identify a specific single compound and a map of the distribution of this compound across the sample can then be generated. However, more complex images may be produced showing the distribution of multiple compounds or different properties.

For a high-resolution hyperspectral image there will be millions of pixels, each representing a full spectrum of hundreds or thousands of sample wavelengths. Such data are well suited to multivariate analysis techniques such as principal component analysis (PCA), principal component regression (PCR), artificial neural networks, linear discriminant analysis, partial least squares (PLS) regression, and multi-component methods. Thus, using such known techniques a regression vector b can be generated using spectral data from mixtures of known composition. This vector relates composition to spectral data and so the vector can be regarded as a model to predict compound concentrations or properties from the spectral data.

As noted above, each pixel in the hyperspectral image will have associated with it an entire spectrum—i.e. a set of intensity values corresponding to each sample wavelength—which is a line, or vector, in the hypercube. When these values are multiplied by the corresponding coefficients of the model vector, the result is the predicted concentration value of the compound in question at that pixel. Thus, considering a pixel at position (i,j), the intensity y₍ᵢⱼ₎ at that point is given by:

y₍ᵢⱼ₎=₍ᵢⱼ₎x₁b₁₊₍ᵢⱼ₎x₂b₂+ . . . +₍ᵢⱼ₎xₙbₙ

where ₍ᵢⱼ₎xₙ is the intensity value at wavelength n and bₙ is the corresponding model vector coefficient. Thus,

y₍ᵢⱼ₎=_{(i,j)}x^{T}b

where _{(i,j)}x comprises the intensity values x₁ . . . xₙ at point (i,j).

The hypercube X of all the spectral data can be analysed by considering it as a series of two-dimensional “slabs” which can readily be handled as matrices. The slabs are all parallel to each other in the hypercube; in other words, the complete cube is effectively sliced up like a loaf to form a set of matrices whose dimensions correspond to those of one of the faces of the hypercube. There are three main ways of slicing the cube into slabs: matrices of size [M×K] along the x-direction, [N×K] along the y-direction and [N×M] along the z-axis. Thus, one slab is matrix Xᵢ (having dimensions [M×K] or [N×K]) which comprises the intensity values of row or column i of pixels and so the concentration values for the corresponding row or column in the chemical image are given by:

yᵢ=Xᵢb

By repeatedly multiplying such matrices of data obtained from successive slabs of the hypercube by the model vector, estimates of the property across the entire image are provided. This may provide, for example, a map of the concentration of a compound such as glucose across the surface of the sample.

Classical hyperspectral imaging is performed using one of two basic principles: scanning by a pushbroom approach or by a tuneable filter approach, for example using an Acousto-Optic Tuneable Filter (AOTF).

In a pushbroom scanner, a line camera is used where the light is diffracted into different colour/wavelength components using a spectrograph onto a focal plane array (FPA). Thus, for each position of the line camera a spectrum is obtained for each point on that line. From the FPA, this data is subsequently streamed into a memory storage as the matrix of spectra Aj. The index j indicates scanned line j. The dimensions of matrix Aⱼ are [M×K] where M is the number of spatial points along the line and K is the number of separate wavelengths in each spectrum. When scanning an area, hundreds or thousands of lines will be read into the camera to provide the hypercube H comprising the set of matrices Aⱼ for all values of j (i.e. all lines). Each matrix Aⱼ is a “slab” of the hypercube representing a line of the image.

In the tuneable filter approach, instead of scanning the image stepwise in one spatial dimension, as in the pushbroom scanner, the entire spatial image is imaged while the camera scans through the different wavelengths. This is achieved by placing the tuneable filter between the image and the camera. AOTFs are particularly powerful tuneable filters. They are solid-state devices comprising a crystal filter whose transmission wavelength is controlled by attached piezoelectric transducers. The transducers create pressure waves in the crystal which changes its refractive index. These transducers are controlled by careful manipulation of the frequency of an applied electric field to vary the transmission wavelength of the filter in a stepwise manner. At each wavelength step, an image is captured which provides a matrix Iⱼ where j is the wavelength step. Thus, each matrix Iⱼ represents a single monochrome image of the whole sample at wavelength j. Like matrices Aⱼ, matrices Iⱼ are read into memory where they each form a slab of the hypercube H. (However, it will be noted that the two kinds of matrices contain different sets of information; they are orthogonal to each other in the hypercube).

Thus, in each approach, the hypercube is generated slab-by-slab and stored in memory. The data is then processed as described above in order to produce the desired output image. The choice of approach is a matter of design optimisation. The spectrograph in a pushbroom system provides better spectral resolution, but at a cost of speed compared to the tuneable filter system where the lack of moving parts enables the hypercube to be generated more rapidly.

It would be desirable to have hyperspectral cameras which can perform chemical imaging of their surroundings in real-time. However, current technology does not easily allow for this. A prototype real-time multispectral system is described in “SmartSpectra: Applying multispectral imaging to industrial environments”, Vila, et al, Real-Time Imaging 11 (2005) 85-98. This uses an AOTF which is controlled not only to select pass-wavelengths, but also to vary their intensity. Varying the intensity of the light of a given wavelength by a predetermined amount is effectively an analogue method of calibrating the input light intensity to provide an output intensity value that can be represented directly in the chemical image. Thus, this system avoids the need for the calculation steps discussed above. However, it has significant drawbacks. The system is multispectral—it uses only six input wavelength bands—and the analogue calibration method is inherently less flexible and less precise than the digital systems used in the hyperspectral systems discussed above.

The most serious problem with the conventional digital approach is how to deal with the enormous amount of data which is generated by the hyperspectral camera. As discussed above, each image results in a hypercube which has two spatial dimensions and one wavelength dimension. If real time imaging is to be achieved, this data must be collected and processed at a rate of about 20-30 frames per second. Recording such a data cube multiple times per second is very difficult, but in theory possible if the cube is small enough, i.e. by making compromises with respect to spatial and/or wavelength resolution. However, the achievement of high resolutions in the spatial and wavelength dimensions is not possible with the prior art systems. There are solutions today which provide real-time multispectral cameras, but these only use a small number of wavelengths. The spectral resolution is also not sufficient for many purposes.

According to a first aspect of the invention there is provided a method of generating a chemical or property image of a sample from hyperspectral image data obtained from that sample comprising the steps of:

(a) obtaining only a portion of the hyperspectral image data;

(b) processing the said portion of the hyperspectral image data using a model to generate spatially resolved chemical composition data or other property data concerning the sample;

(c) repeating steps (a) and (b).

Thus, by means of the present invention, the generation of the chemical composition data, which may, for example, be presented in the form of a chemical image, is interleaved with the obtaining of the hyperspectral image data. In other words, the image is processed whilst scanning takes place. This is in contrast with the prior art digital methods where, as discussed above, the entire image data set is obtained and stored as a hypercube before being processed. Preferably, only the slab that is being processed is held in memory. The invention therefore avoids the use of a huge amount of computer memory, which is highly advantageous in itself. However, a greater benefit is the increased speed of the process by avoiding the need to address so much memory.

Consequently, provided that the invention is implemented using suitably fast hyperspectral and processing hardware, real time chemical images are possible.

Steps (a) and (b) will normally be repeated until the chemical or property image has been completed, although there may be applications where the process is truncated, for example where a high frame-rate takes priority or where only a partial image is required, thus every nth line could be omitted.

The invention also extends to apparatus employing these methods and so, viewed from another aspect, the invention provides an apparatus for generating a chemical or property image comprising a hyperspectral camera for obtaining hyperspectral image data from a sample and a processor for generating chemical or property image data from sample image data using a model, wherein the processor is arranged to obtain from the camera only a portion of the hyperspectral image data and to processes said portion of the hyperspectral image data using the model to generate spatially resolved chemical composition data or other property data concerning the sample before obtaining and processing further samples of data.

The term “hyperspectral camera” includes any hyperspectral image input device including those discussed above. The apparatus may also comprise a suitable display unit to display an image formed by the chemical composition or other property data. The processor preferably repeats the obtaining and processing steps until a complete set of chemical or property image data has been produced.

The invention can be applied to both the hyperspectral imaging techniques referred to above. (Indeed, it can also be applied to mutispectral techniques.) Thus, where a pushbroom line scanner is used, each line of the scan may comprise a portion of the hyperspectral data. In a typical spectroscopic application, the portion of data therefore comprises a series of spectra corresponding to points on the sample along the line. This may be represented as a matrix whose dimensions are the number of points and the number of sample wavelengths respectively.

This data is then processed using a model as in the known techniques. Thus, the model may comprise a regression or classification vector generated theoretically or obtained from samples having known properties, for example using the known chemometric techniques discussed above. Any such model in the form of a vector will be referred to here as a model vector.

Preferably, the matrix is multiplied by the model vector to obtain image data for a line of a chemical image. This may, for example, provide a map of the distribution, and optionally concentration, of a given compound on (or in) the surface of a sample. This step is performed with the image data just after it has been obtained by the camera. Thus, there is no need to keep the matrix data after it has been processed in this way, and indeed it is preferred that it is overwritten in order to avoid unnecessary memory usage. As such, it is greatly preferred that no complete hypercube of camera image data is ever stored in memory.

If desired, a plurality of models (e.g. regression vectors) can be used corresponding to a respective plurality of compounds that are to be detected or properties. This can be done to provide multiple chemical images or single images using, for example, different colours to represent the presence of different compounds or properties. Although it is possible to use each vector sequentially, it is preferred to combine them into a matrix and to multiply the image matrix by this model matrix.

As the images can be produced in real time, the result can be displayed on a computer monitor or the like as a moving image.

Where the tuneable filter approach is employed, each image of the sample at a given sample wavelength may comprise a portion of the hyperspectral data. Thus, typically, the portion of data therefore comprises a monochromatic image. This may be represented as a matrix whose dimensions correspond to the linear dimensions of the image. As with the pushbroom approach, the model may be in the form of a regression vector.

However, in this approach, the coefficient of the model vector corresponding to the sample wavelength of the monochromatic image is preferably used to multiply each element of that matrix. The result may then be stored (e.g. in a particular computer memory location) as a further matrix. The next monochrome image, for a further wavelength is then obtained and each pixel intensity value multiplied by the coefficient of the model vector corresponding to the new sample wavelength to form a new matrix, which is then added to that in the memory. When this has been repeated for each wavelength that is required to be sampled, the memory will contain a complete set of data for a chemical image.

It is possible to sample every available wavelength sequentially. However, preferably only a selected subset of the available wavelengths are sampled.

It will be appreciated that where the model vector coefficient is zero, the result of the multiplication step is also zero. (Likewise, when the coefficient is small then the result is close to zero.) Consequently, it is preferred that where the coefficient is zero, no sample image is obtained at that wavelength. This has the advantage of speeding up the process.

It may also be desirable in some applications where speed is of greatest importance, to selectively omit sampling for other coefficient values, e.g. where these approximate to zero. Indeed, it is possible to be more selective and to choose to apply only a subset of the most important coefficients by applying known variable selection techniques.

In certain embodiments, a desired subset of sample wavelengths may be pre-determined based on expert knowledge. Where specific compounds are being targeted, their most characteristic frequencies may be selected to form part or all of the subset.

Although the wavelengths could be sampled in any order, and may be sampled in sequence (whilst optionally omitting a selection as discussed above), it is preferred that the wavelengths are sampled in order of importance or magnitude of the model coefficients. It is a characteristic of tuneable filter systems that they can switch wavelength at an extremely high rate so this can readily be accommodated.

Thus, the wavelengths corresponding to the largest value coefficients may be sampled first. Most preferably, the wavelengths are sampled in order of decreasing importance or magnitude of the corresponding model coefficients.

Particularly (but not only) when the sampling in order of decreasing importance or magnitude, the number of wavelengths actually sampled can be varied. Thus, when a higher frame rate is required (for example if the sample is moving) a smaller number of wavelengths can be sampled. If the wavelengths are sampled in such an order, then the “lost” data will always be the least important.

The techniques discussed above using multiple model vectors and those relating to displaying the results are equally applicable to a tuneable filter based system. Moreover, the principles described concerning the selection of the most important or largest (in absolute value) coefficients may also be applied to a pushbroom type system by providing a focal plane array that reports intensity values for only a subset of wavelengths.

It will be appreciated that the invention also extends to apparatus arranged to carry out any of the preferred forms of the above method, e.g. using tuneable filter or pushbroom approaches. It is envisaged that the processing steps will be carried out by computer processor(s) and so the invention also extends to computer apparatus configured to process data according to the above method.

As noted above, one suitable way to display hyperspectral or chemical/property imaging data is to use a computer monitor and where the data is real-time, or recorded for that matter, it may be displayed as a moving picture, for example as the hyperspectral camera (i.e. input device of whatever kind) moves around a three dimensional object or as the object moves. This enables, for example, the searching of an area (a room, human body, etc.) for traces of particular compounds such as explosives or narcotics. It is also possible to use other known displays.

However, each of these has the drawback that whilst a map or image showing the distribution of the compound or property in question is provided, it can be problematic to correlate a point on the image with the same point on the imaged surface in order, for example, to take a physical sample.

One approach to this is to use goggles or head-up display technology so that an image is provided to a user which overlies the subject of that image in the view of the user. This is a useful approach when the operator is not close to the subject or wishes to monitor it without being detected.

However, in other applications this may cause drawbacks because the image can only be seen by a single user and there may be a problem in registering the image in the goggles with the field of view of the user. Preferably, therefore, the image data obtained by the method and apparatus described (particularly in their preferred forms) above is visualised by back-projecting it onto the imaged object.

This concept is regarded as being inventive in its own right and therefore, viewed from a further aspect, there is provided a method of generating a chemical image of an object comprising the steps of obtaining hyperspectral image data, processing it to provide a chemical image, and projecting the chemical image onto the object.

Thus, the image may be provided in register with the imaged object so that compounds or properties detected in the image may be located on the object. The spatial distribution of compounds or properties in/on the object may also be readily visualised. The image may be only of part of the object, but can be projected back onto the corresponding part of the object. It will be appreciated that the chemical image may then be seen by any number of viewers. Other kinds of property image may also be visualised in this manner.

The invention also extends to a corresponding projection apparatus and so, viewed from a further aspect the invention provides an apparatus for generating a chemical image of an object comprising a hyperspectral camera arranged to receive light from an object and to output hyperspectral image data, a processor for processing the hyperspectral data to provide a chemical or property image, and a projector arranged to project the chemical or property image back towards the object.

Preferably the light enters the camera along the same optical axis as the image is transmitted back to the object. The projection apparatus may incorporate a rotating mirror, or other arrangement to allow light from the imaged scene to pass into the apparatus via the same optical system as that which projects back the image. Such an arrangement switches the light path as it rotates. It is also possible to use a half-silvered mirror. This has the advantage of eliminating moving parts.

Where this is done but it would be necessary to take steps to prevent the projected image interfering with the sampled light. For example, the detected frequencies of light may be selected to differ from those used in the projected image. In this regard, a filter may be provided (e.g. just in front of the camera) to filter projected light frequencies from the light passing into the hyperspectral camera and/or a filter may be provided (e.g. just in front of the projector) to filter the frequencies being detected from the projected light.

Another approach is to use a laser projection system to draw the real-time images onto the sample surface. There are several advantages to using laser projection. One is that the operating wavelength of the laser can readily be selected to be outside the detection range of the hyperspectral camera which will permit the recording and drawing of results to be performed simultaneously without the need for any shutters. Another advantage is that lasers minimize the problem of focus when drawing on surfaces.

Applications include surveillance, forensic science, robotics, medical, biological and chemical science or monitoring activities where the user is closely investigating the surfaces of objects for different types of chemicals/properties. The system may, for example, be used in place of known systems using fluorescence for detecting blood in crime scene investigations. Here the user wears goggles for filtering certain wavelengths and a special lamp is used for inducing fluorescence. However, this known system has several disadvantages in that the user usually needs to spray a substance onto surfaces that react with the blood, he must switch off other light sources that can disturb the observation process and of course, the use of special goggles further reduces the visibility of the scene.

With the new system the user is able to work in full daylight or in a heavily illuminated area. The results from the chemical/property imaging method of this invention may be seen in the original scene itself as patterns and spots of bright artificial colours. This has a large impact on the user-friendliness of the system because it will allow the user, for example a forensic science investigator, to focus on the objects in the scene in a natural way and at the same time obtaining the additional information originating from the chemical/property imaging. This is a much less cumbersome and difficult approach to inspection than using goggles or computer screens.

In fact, the more light there is available, the better the hyperspectral camera will work. Preferably, the apparatus is configured so that the user is able to switch rapidly between different types of chemical/property image models, e.g. from ethanol to blood to gunpowder to TNT in rapid succession. In fact, the use of multiple artificial colouring makes it possible to overlay the results from more than one model onto the scene. However, it should be kept in mind that the original colours of the objects in the scene may mask or make it difficult to differentiate with respect to the chemical/property images projected onto it and so, preferably, this is taken into account, for example by allowing variation in the colours used for the projected image.

Preferably, the back projection is provided by sampling light from a source with a hyperspectral camera, generating a chemical/property image therefrom and then projecting the estimated chemical/property image onto the scene.

This is done repeatedly, preferably at a sufficient rate to give a real time or quasi-real time image. For non-moving objects it may be acceptable to use a frame rate of 3-10 frames per second (fps), provided that the apparatus is not moved quickly. Preferably, however, a rate of 10-20 fps or more is used and most preferably it is 25-30 fps, as with a TV or cinematic image.

It will be appreciated that the above processing techniques will normally be performed by means of software running on suitable computer apparatus. The invention therefore also extends to such computer apparatus and to software arranged to cause such apparatus to perform the processing methods of the invention. Thus, according to further aspects, the invention also extends to a software product whether in tangible form (e.g. on disk) or obtained by way of download etc., configured to provide chemical or property image data from hyperspectral data in accordance with the above methods and/or for causing a computer to perform such a method.

Preferably, the apparatus is provided in the form of a hand-held device which can readily be directed at any object by the user.

Certain embodiments of the invention will now be described, by way of example only, and with reference to the accompanying drawings:

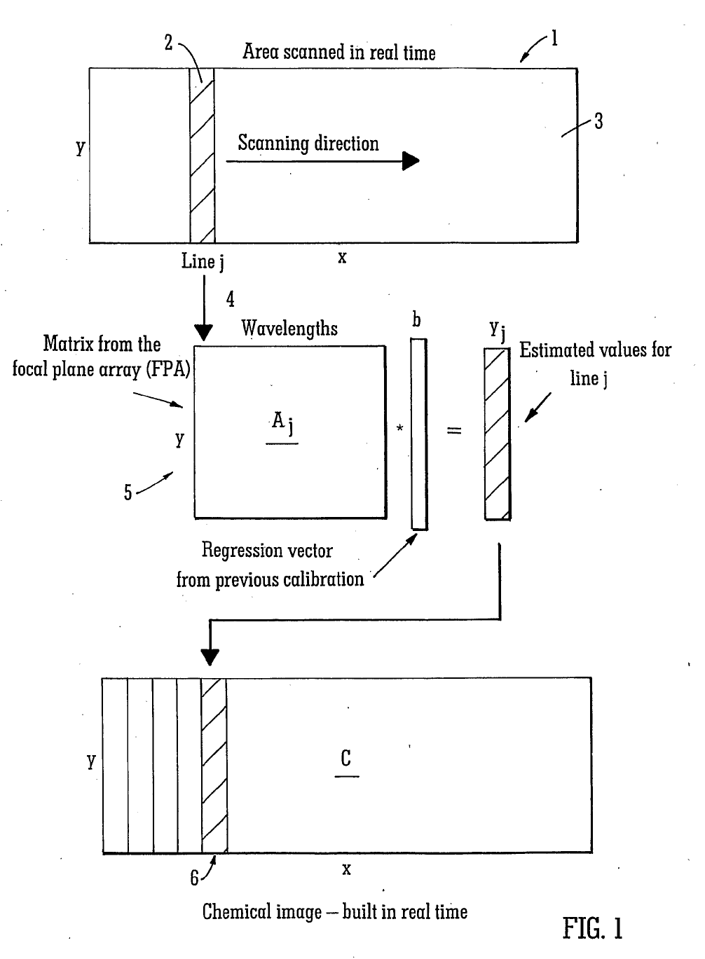

FIG. 1 is a schematic illustration of an apparatus for generating a chemical image according to first embodiment of the invention using a pushbroom approach;

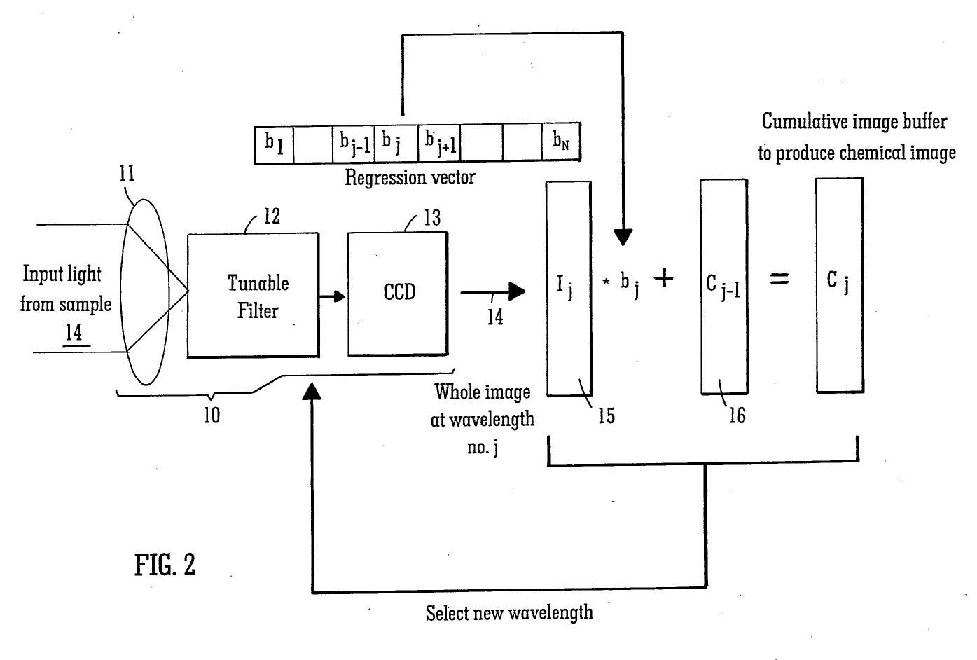

FIG. 2 is a schematic illustration of an apparatus for generating a chemical image according to a second embodiment of the invention using the tuneable filter approach;

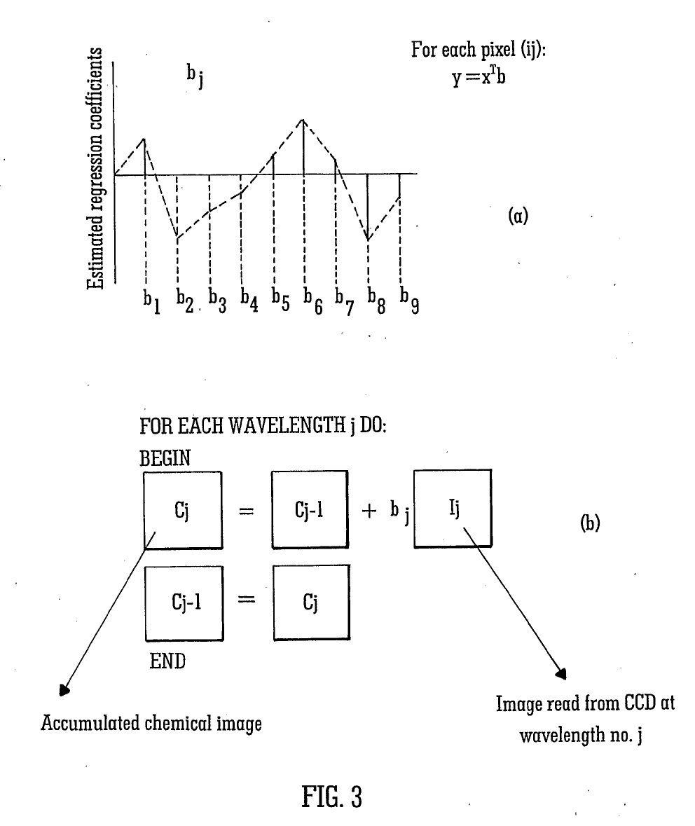

FIGS. 3(a) and (b) further illustrate the operation of the second embodiment;

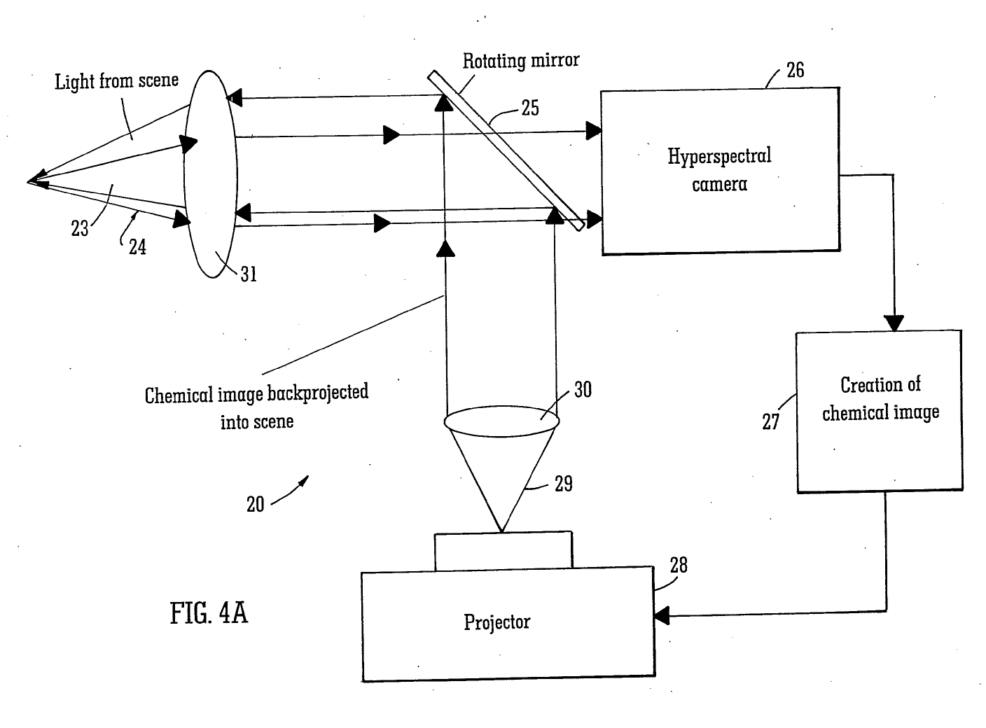

FIG. 4A is a schematic diagram showing the operation an apparatus for projecting a chemical image in real time onto a surface and which employs a normal light projector;

FIG. 4B is a schematic diagram showing the operation an apparatus for projecting a chemical image in real time onto a surface and which employs a laser projector;

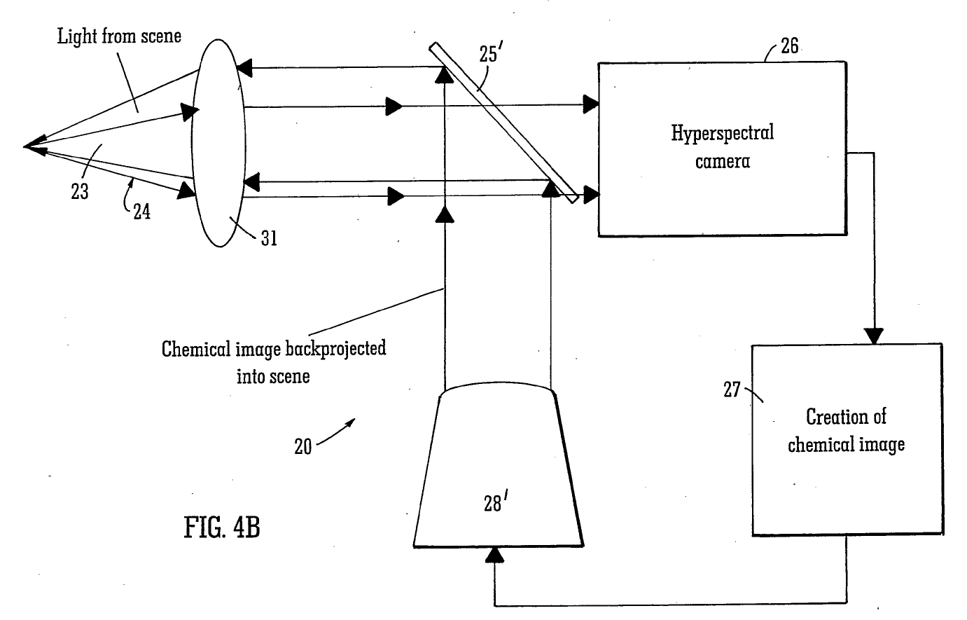

FIG. 5 illustrates the use of the apparatus of FIG. 4A or 4B; and

FIG. 6 is a schematic illustration of a prior art hypercube of spectral data.

With reference to FIG. 1, a conventional pushbroom scanner apparatus 1 comprises a line camera 2, which is arranged to scan line-by-line across a sample 3. The camera contains a spectrograph (not shown) where the light is diffracted into different colour/wavelength components before the being detected by a focal plane array (FPA). This provides a digital output 4 which comprises a spectrum of K wavelengths for each of M pixels.

The output for each line numberj is subsequently streamed into memory storage 5, which is part of a data processing apparatus (not shown), in the form of a matrix Aⱼ. The dimensions of matrix Aⱼ are [M×K] where M is the number of spatial points along the line and K is the number of wavelengths in each spectrum. When scanning an area, hundreds or thousands of lines will be read into the camera. As discussed above, the traditional approach is to store Aⱼ in a 3D hypercube (array). This is not done in the present invention which consequently is much faster. The next steps involved in this embodiment are as follows:

Matrix Aⱼ is multiplied directly by a vector b, which has been obtained by a regression analysis in the known manner. This step is carried out immediately after the matrix is read into memory. FIG. 3(a) is a schematic graph showing a plot of regression coefficients by for j=1 to 9, i.e. the 1st to 9th coefficients of the vector b. As in the prior art, it maps from spectrum to the relevant value (e.g. the concentration of compound which is to be detected in the image). Thus for the single line j recorded, the system performs:

yⱼ=Aⱼb (1)

where yⱼ is the estimated value vector which gives the values (e.g. of the concentration of the compound) for each point in line j.

The next step is to insert yⱼ as column j (reference 6) into a new matrix C which provides the data for the chemical image. Initially, C=0. Thus, the concentration values or other data are mapped to a position in matrix C which corresponds to the spatial position in the sample from which that value was derived.

Subsequently, the scanner's line camera 2 is moved to the next line j+1 and the process above is repeated. This is done for each line until the entire sample has been imaged and the chemical image completed. The image may then be transmitted to, and shown on, a conventional computer monitor (not shown) with, for example, a grey-scale indicating the concentration of the compound being detected.

It will be seen that in this way the chemical image of a scene is generated on the fly as the scanner moves across the surface of the sample. Provided that highly parallel and fast hardware is employed, it is possible to perform the multiplication in Equation (1) extremely quickly so that it will not be a serious bottleneck in the process of scanning one line j to the next j+1. In this way, matrix C is recreated several times per second which means that real-time or near real-time imaging can be achieved by rapid line scanning across the sample at a corresponding frame rate.

In a modified version of this embodiment, multiple vectors yⱼ corresponding, for example, to a plurality of different compounds can be obtained as a matrix Yj using a matrix B of regression coefficients:

Yⱼ=AⱼB (2)

This means that a corresponding plurality of matrices C are then generated. The concentrations of the different compounds can then be provided in separate images, or in the same image. This can be done by using the intensity of a given colour in the image to represent the concentration of a particular compound. However, it will be appreciated that this will require a very high degree of processing power and may therefore only be practicable where specialist computers can be employed.

A second embodiment of the invention is shown in FIG. 2. This apparatus is based on the tuneable filter approach discussed earlier. The camera apparatus 10 itself is essentially conventional and comprises an objective lens 11, an Acousto-Optic Tuneable Filter (AOTF) 12 and a charge-coupled device 13.

Input light 14 reflected from the surface of a sample (not shown) passes through lens 11 before being filtered by AOTF 12 and the light which falls within the narrow pass-band of the filter 12 is then detected by CCD 13 to provide a two-dimensional greyscale image for that band (which for practical purposes is regarded as being a single wavelength). This is output as signal 14 to data processing apparatus (not shown). The pass-band frequency of the filter is varied to allow detection of images for a large number of light wavelengths. Conventionally, the filter would scan stepwise through the IR or NIR band.

The CCD 13 is synchronised with the operation of the filter 12 so that the entire image is captured and output before the pass-frequency is changed. The output signal 14 for the jth pass-frequency is stored as a matrix Iⱼ in memory buffer 15. This matrix has dimensions corresponding to the numbers of pixels in the x- and y-directions on the CCD.

As indicated earlier, the conventional method for processing the data is to create a hypercube from the full set of matrices Iⱼ and then to multiply each of the pixel intensity values forming the hypercube by a regression vector (or vectors if, for example, a plurality of compounds are to be detected), in the same way as a hypercube created by a conventional pushbroom apparatus.

The present embodiment takes advantage of the fact that it is possible to control AOTFs to enable great flexibility in how individual wavelengths are manipulated. AOTFs are solid-state devices controlled by attached piezoelectric transducers. These transducers can be controlled by careful manipulation of their applied frequencies to select a particular pass-frequency. In this embodiment, instead of simply scanning through each wavelength in turn, the control of which wavelengths are transmitted through the filter is determined by the model vector b which has previously been created in the conventional manner using spectra of the same type as observed in the hyperspectral camera.

If it is desired to provide a chemical image of the distribution of a plurality of compounds, a corresponding number of regression vectors is used. Thus, to see the distribution of e.g. glucose or methanol, there will be available corresponding regression vectors b_{glucose} and bₘₑₜₕₐₙₒₗ.

The regression vector(s) will contain j coefficients (i.e. one for each wavelength that is detected) and a number of these will be zero or close to zero. Since the product of any matrix coefficient with a zero vector coefficient is obviously zero, there is no need to sample light at that wavelength and so the filter is never set to pass that wavelength. Likewise, very small coefficients will have a negligible effect on the result. To gain even more parsimonious models, various variable selection methods can be used to create models with high precision and small numbers of variables. In other words, to be even more efficient, the apparatus only studies the wavelengths that are necessary to achieve the desired accuracy.

Thus, to produce chemical image data for a given compound, the apparatus steps through each possible input light wavelength in turn and where (but only where) the corresponding regression vector coefficient j is significantly different from zero, the following farther steps are carried out:

Firstly, the filter 12 is controlled in the conventional manner to let through light at the wavelength corresponding to the non-zero coefficient j. The CCD 13 then records the light falling on it and sends the resulting data 14 to a memory storage 15 in the data processing apparatus where matrix Iⱼ is stored temporarily replacing the previous content of that storage.

The next step is to multiply each element/pixel in matrix Iⱼ by bⱼ (the coefficient—a scalar—for the sampled wavelength) and add the result to matrix Cⱼ₋₁ which is located in another storage 16. Initially, when j=1, Cⱼ₋₁=C₀=0, i.e. it is an empty memory storage with only zeros. See FIG. 3(b).

It is important to note that Cⱼ is overwritten once for each regression coefficient. At the end, each element in Cⱼ will contain the finished predicted concentration of a chemical compound or modelled property for every pixel. It will be seen that this is achieved with most of the computation of the chemical image taking place in memory directly connected to the charged coupled device and without the need to generate, store and then process a hypercube.

When all the wavelengths have been stepped through, the matrix C is complete for the intended compound concentration or property. This takes a fraction of a second and can be repeated many times to enable real-time imaging. The process can then be repeated for the other compounds or properties using a new regression vector and then image(s) can be displayed as with the previous embodiment.

The working of this embodiment can be understood by assuming that we have a hyperspectral data cube X. A spectrum x^{T} for a certain pixel is then multiplied by the corresponding regression vector b to produce the estimated value:

yⱼx^{T}b=b₁x₁+b₂x₂+ . . . +bⱼxⱼ (3)

Note that yⱼ is a scalar which is the result after having added the contribution from the wavelength indices from 1 to j≦K. The best result will usually be after all K relevant wavelengths have been used. We would have needed to perform one such multiplication for every pixel in the hyperspectral image to obtain a predicted chemical image C. This is very time consuming, but here in this invention, everything happens in parallel by using whole image buffers and not storing data for more than necessary to perform simple addition and multiplication operations. Assume that each image plane for wavelength index j is Zⱼ. Thus Zⱼ is a proper image recorded at wavelength j. The parallel version of Equation 3 is therefore:

Cⱼ=Z₁b₁+Z₂b₂+ . . . +Zⱼbⱼ (4)

Since we do not store every Zⱼ the process controlled at the speed of the AOTF can also be written as:

Cⱼ₊₁=Cⱼ+Zⱼ₊₁bⱼ₊₁ (5)

To accomplish real-time performance, very fast electronic components should be used in connection with the AOTF. In addition, the storage 16 containing C should be updated at maximum clock frequency in synchronization with the AOTF to deliver optimal performance.

In both embodiments, the camera is controlled in response to the calculation steps. Thus, the completion of one round of calculations triggers the output of the next matrix of data from the camera.

FIG. 4A illustrates schematically the operation of an embodiment of the invention, which is an apparatus for displaying chemical images such as those obtained in the previous embodiments, and specifically, it relates to an apparatus using a tuneable filter as described above with reference to FIG. 2. It projects a chemical image of an object back onto that object. FIG. 5 illustrates this apparatus 20 being used by a user 21 to image an object 22. Region 23 is where light travels from the object to the apparatus 20 and back from the apparatus as it projects onto the object.

Returning to FIG. 4A, light 24 from the object 22 (which is illuminated by natural light) passes through an objective lens 31 of the apparatus. In its path is rotating mirror 25 and when the mirror is parallel to the path of the rays of light 24, the light is allowed to pass on to hyperspectral camera 26 which is of the AOTF type. The output from the camera is transmitted to processor 27 where the chemical image data is generated. The camera 26 and processor 27 operate in the manner discussed above whereby a series of monochromatic images are passed to the processor and the image is built up as the camera scans through the appropriate wavelengths.

The image data is then transmitted to a projector 28 whose output image is focussed by lens 30 towards the rotating mirror 25. When the mirror is in the position illustrated, the image is reflected off the mirror and back through lens 31 to the imaged object 22.

It will be appreciated that as the mirror rotates, the apparatus alternately samples light from the object 22 and projects an image onto it. The mirror rotates at sufficient speed that the impression of a continuous image is provided.

To minimize interference between projection and detection, in a modified embodiment, proper filtering of the projection light is performed. In cases where the hyperspectral detector is operating outside the visible range, e.g. in the UV or (near) infrared, various filters can be used to block any contributions from the projector in the detection range of the camera. It should be pointed out that such filters may need to be cooled to avoid over-heating.

When using ordinary light projectors there is a need to focus the system which is achieved in this embodiment using known dynamic autofocussing apparatus (not shown) in which a laser is provided to rapidly measure the distance from the projector to the surface. The laser is provided in the body of the apparatus and arranged to direct its beam parallel to the optical axis such that it reflects off the sample that is being imaged. The reflected laser light is then detected and the focus adjusted accordingly in the known manner. (In other embodiments, alternative known rapid autofocussing techniques may be used.) As the hyperspectral camera is moved, the autofocussing system dynamically ensures that the backprojected image onto the surface stays in focus.

In a further embodiment of the invention shown in FIG. 4B, in place of the ordinary light projection system just described, a laser projection system is used to draw images onto the sample surface. The frequency of light used for projection is chosen to be significantly shifted from that used for imaging and therefore the rotating mirror is not required.

The arrangement of components in this embodiment corresponds to those in described above in relation to FIG. 4A with the following modifications (reference numerals corresponding to those in FIG. 4A are used for common components). The normal light projector and lens is replaced by a laser projector 28′ and a half-silvered mirror 25′ is provided in place of the rotating mirror to allow simultaneous imaging and projection along a common axis. Thus, light from the sample may pass through the half-silvered mirror to the hyperspectral camera and light from the laser projector is reflected from the mirror 28′ and back towards the sample.

An advantage of the use of laser light for projection is that is minimizes focussing problems. Furthermore, the frequency of light used for projection is chosen to be significantly shifted from that used for imaging to minimize the interference between the detection and projection parts of the system. This embodiment, also has the advantage of not requiring moving parts, i.e. the rotating mirror.

For example, where near infra-red imaging is used (say 900-1500 nm), lasers with wavelengths of 500-600 nm may be used for projection.

It will be appreciated that in either embodiment, where ambient light does not provide the appropriate illumination frequency then a separate light source may be provided, either integrated with the apparatus or separately.

We claim:

1. A method of generating a chemical or property image of a sample from hyperspectral image data obtained from that sample comprising the steps of:
(a) obtaining from the sample only a portion of the hyperspectral image data;
(b) processing the said portion of the hyperspectral image data using a model to generate spatially resolved chemical composition data or other property data concerning the sample; and then
(c) repeating steps (a) and (b).

2. A method as claimed in claim 1, wherein steps (a) and (b) are repeated until the chemical or property image has been completed.

3. A method as claimed in claim 2, wherein only the portion of data is temporarily held in memory when it is processed and subsequently overwritten by a further portion when that further portion is processed.

4. A method as claimed in claim 1, wherein the hyperspectral image forms a hypercube and each portion comprises a matrix forming slab thereof.

5. A method as claimed in claim 4, wherein the matrix comprises a series of spectra corresponding to points on the sample along a line.

6. A method as claimed in claim 5, wherein the matrix is multiplied by a model vector to obtain image data for a line of a chemical image whereby a map of the distribution and/or concentration, of a given compound on or in the surface of a sample is provided.

7. A method as claimed in claim 4, wherein the matrix comprises a monochromatic image.

8. A method as claimed in claim 7, comprising the steps of: (a) using the coefficient of a model vector corresponding to the wavelength of the monochromatic image to multiply each element of that matrix and the result is stored as a further matrix; (b) obtaining the monochromatic image for a further wavelength and multiplying each element thereof by the coefficient of the model vector corresponding to the further wavelength to form a new matrix; (c) adding the new matrix to the further matrix already in the memory; (d) repeating steps (a) to (c) for each wavelength.

9. A method as claimed in claim 8, wherein the wavelengths used in steps (a) to (c) are a subset of the available wavelengths.

10. A method claimed in any of claim 9, where the model vector coefficient for a given wavelength is zero or close to zero no sample image is obtained at that wavelength.

11. A method as claimed in claim 9, wherein the subset of wavelengths used is pre-determined and/or based on information about the importance of specific frequencies for identifying targeted compounds.

12. A method as claimed in claim 8, wherein the wavelengths are sampled in order of decreasing importance or magnitude of the corresponding model coefficients.

13. A method as claimed in claim 1, wherein the resulting images are produced in real time, whereby the result can be displayed on a computer as a moving image.

14. A method as claimed in claim 1, wherein image data is visualised by back-projecting it onto the imaged object.

15. An apparatus for generating a chemical or property image comprising a hyperspectral camera for obtaining hyperspectral image data from a sample and a processor for generating chemical or property image data from sample image data using a model, wherein the processor is arranged to obtain from the sample only a portion of the hyperspectral image data and to processes said portion of the hyperspectral image data using the model to generate spatially resolved chemical composition data or other property data concerning the sample before obtaining and processing further samples of data.

16. An apparatus as claimed in claim 15, wherein the apparatus is of the pushbroom type.

17. An apparatus as claimed in claim 16, configured to operate in accordance with claim 1.

18. An apparatus as claimed in claim 15, wherein the apparatus is of the tuneable filter type.

19. An apparatus as claimed in claim 18, configured to operate in accordance with claim 1.

20. A method of generating a chemical or property image of an object comprising the steps of obtaining hyperspectral image data, processing it to provide a chemical image, and projecting the chemical or property image onto the object in register with the imaged object so that compounds or properties detected in the image may be located on the object.

21. An apparatus for generating a chemical image of an object comprising a hyperspectral camera arranged to receive light from an object and to output hyperspectral image data, a processor for processing the hyperspectral data to provide a chemical or property image, and a projector arranged to project the chemical or property image back towards the object.

22. An apparatus as claimed in claim 21, wherein the light enters the camera along the same optical axis as the image is transmitted back to the object.

23. An apparatus as claimed in claim 22, comprising a rotating mirror arranged to allow light from the imaged scene to pass into the apparatus via the same optical system as that which projects back the image.

24. An apparatus as claimed in claim 22, comprising a half-silvered mirror arranged to allow light from the imaged scene to pass into the apparatus via the same optical system as that which projects back the image.

25. An apparatus as claimed in claim 21, comprising a laser projection system for projecting images onto the sample surface, wherein the operating wavelength of the laser is selected to be outside the detection range of the hyperspectral camera.

26. An apparatus as claimed in claim 21, comprising an auto focusing system that in real-time updates the focus of the light projector.

27. An apparatus as claimed in claim 21, wherein filter(s) is/are provided to eliminate or reduce the overlap of the frequencies of received and projected light.

28. An apparatus as claimed in claim 24, wherein a filter is provided to filter received light prior to being received by the camera and/or a filter is provided to filter projected light.
